(19) United States
(12) Patent Application Publication
(10) Pub. No.: US 2004/0047093 A1
(43) Pub. Date: Mar. 11, 2004

(54) Control method of sliding a vehicle door by a powered sliding device

(75) Inventor: Kazuhito Yokomori, Yamanashi-ken (JP)

Correspondence Address: BROWDY AND NEIMARK, P.L.L.C., 624 NINTH STREET, NW, SUITE 300, WASHINGTON, DC, 20001-5303, US

(73) Assignee: Mitsui Kinzoku Kogyo Kabushiki Kaisha, Tokyo (JP)

(21) Appl. No.: 10/277,223

(22) Filed: Oct. 22, 2002

(30) Foreign Application Priority Data
Oct. 22, 2001 (JP) 2001-323627

(51) Int. Cl. H02H 3/00

(52) U.S. Cl. 361/51

(57) ABSTRACT

In the present control method, by measuring the sliding quantity of a sliding door until the sliding door reaches a door-open end DOE after passing a holder check point HCP, a distance Y from the HCP to the DOE is found. A distance Z′ from the HCP to the opening speed final decelerating position FDP is found from the relation between the distance Y and a specified distance Z by calculation. By the next door opening operation, when the sliding door has passed the HCP and the sliding quantity from the HCP becomes equal to the distance Z′, the controller 32 judges that the sliding door has reached the final decelerating position FDP, and decelerates the sliding door.

### BACKGROUND OF THE INVENTION

1. Field of the Invention

The present invention relates to a control method of sliding a vehicle door by a powered sliding device, and particularly, relates to the quality control for improving the operating feeling at the time of the finish of the opening sliding movement of the door.

2. Description of the Related Art

Conventionally, a powered sliding device for a vehicle sliding door has been well known, wherein the sliding door is slid in the door closing direction and in the door opening direction by rotating a wire drum connected through a wire cable to the sliding door by the power of a motor, and the sliding door moved to the door-open position by the sliding device is kept at the door-open position by a door holder.

In the door holders, there are a mechanical engaging type holder which uses a latch/ratchet mechanism and a striker, and an overcoming type holder which uses an elastic projecting strip such as a plate spring or an inelastic projecting strip. The overcoming type holder is provided at a proper position of the vehicle body, and keeps the door at the door-open position by coming into contact with part of the door. Here, as shown in FIG. 5, the door-open position means a position between the mechanical door-open end DOE which is the moving limit of the door and the position MRP where the door receives the maximum overcoming resistance from the door holder, and generally, it has a width of about 20 to 40 mm.

The sliding door positioned at the door-open position is detected by a holder switch. The holder switch detects whether the sliding door is positioned at the door-open position or the sliding door is not positioned at the door-open position. However, it is very difficult to accurately set the on/off switching position (holder check point HCP) of the holder switch at the maximum resistance position MRP of the door holder, and therefore, generally, the holder check point HCP is set on the door closing side of the maximum resistance position MRP.

The holder check point HCP is also used as the reference point of decelerating the sliding speed of the door, and it is arranged that when the sliding door passes the holder check point HCP by the opening sliding movement, the sliding door is decelerated, and runs into the door-open end DOE at a slow speed.

If the speed is fast when the sliding door runs into the vehicle body at the door-open end DOE, a good operating feeling of the sliding door cannot be obtained, and furthermore, the durability of the sliding door is lowered. However, if the timing of decelerating the sliding speed is early, it takes a long time to finish the sliding movement.

### SUMMARY OF THE INVENTION

Therefore, it is an object of the present invention to provide a quality control by which it is possible to accurately set the final decelerating position of the sliding door on the door opening side of the maximum resistance position MRP of the door holder.

### BRIEF DESCRIPTION OF THE DRAWINGS

FIG. 1 is a side view of a vehicle with a powered sliding device and a sliding door;

FIG. 2 is an expansion plan of the sliding device and the sliding door;

FIG. 3 is a block diagram for performing the control operation of the present invention;

FIG. 4 is an explanation figure showing the relation of a plurality of setting positions set near the door-open position of the sliding door; and

FIG. 5 is a figure of a well known example showing the relation of a plurality of setting positions set near the door-open position of the sliding door.

### DESCRIPTION OF THE PREFERRED EMBODIMENT

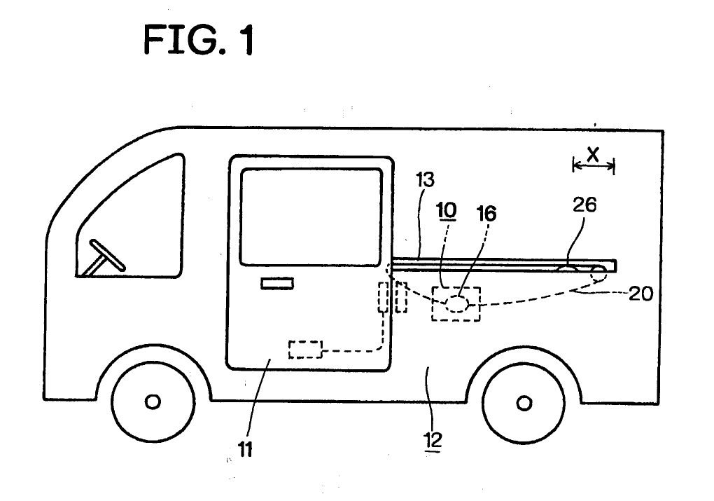

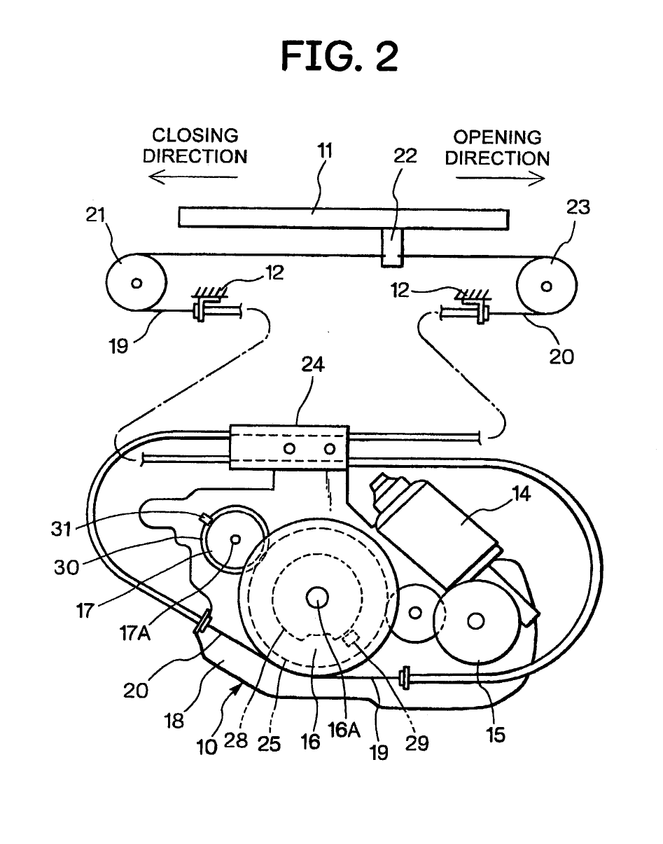

One preferred embodiment of the present invention will be described by using drawings. FIG. 1 shows the schematic relation between a powered sliding device 10 according to the present invention and a vehicle sliding door 11 which is slidable in the door closing direction and in the door opening direction by the powered sliding device 10, and FIG. 2 shows the expanded relation of both.

The sliding door 11 is slidably attached to a vehicle body 12, and slides in the back and forth direction of the vehicle body 12 along a guide rail 13 provided to the vehicle body 12. The sliding device 10 has a motor 14, a reduction mechanism 15, a wire drum 16, and an auxiliary brake 17, and these are attached to a base plate 18 fixed to the vehicle body 12. The auxiliary brake 17 has electrical control parts such as a solenoid, and when operating, it gives rotational resistance to the wire drum 16. The rotational shaft 17A of the auxiliary brake 17 rotates together with the rotation of the wire drum 16 when the auxiliary brake 17 is not operated.

To the wire drum 16, one end sides of two wire cables 19, 20 are connected. The other end side of the first cable 19 is connected to a bracket 22 of the sliding door 11 through a front pulley 21 pivoted to the vehicle body 12. Similarly, the other end side of the second cable 20 is connected to the bracket 22 of the sliding door 11 through a rear pulley 23 pivoted to the vehicle body 12.

To the base plate 18, a tension case 24 having a tension spring in the interior (not shown) is fixed by a screw or the like. The wire cables 19, 20 extending from the wire drum 16 pass in the tension case 24 to be connected to the sliding door 11, and a specified tension is applied by the tension spring.

Between the reduction mechanism 15 and the wire drum 16, a clutch mechanism 25 is provided, and the rotation of the motor 14 is transferred to the wire drum 16 through the reduction mechanism 15 and the clutch mechanism 25. The structure of the clutch mechanism 25 is free. For example, an electromagnetic clutch which can be switched to the connected state and the disconnected state between the motor 14 and the wire drum 16 by the operation of an electromagnet, or a clutch which is switched to the connected state when the motor 14 rotates and switched to the disconnected state when the motor 14 stops, or a clutch which is switched to the connected state by the rotation of the motor 14 but which can keep the connected state even when the motor 14 is stopped (refer to U.S. Pat. No. 6,359,762), or the like can be used.

When the wire drum 16 rotates clockwise by the power of the motor 14, the first wire cable 19 is wound up, and at the same time, the second wire cable 20 is pulled out, and the sliding door 11 slides in the door closing direction, and by the counterclockwise rotation of the wire drum 16, the second wire cable 20 is wound up, and at the same time, the first wire cable 19 is pulled out, and the sliding door 11 slides in the door opening direction.

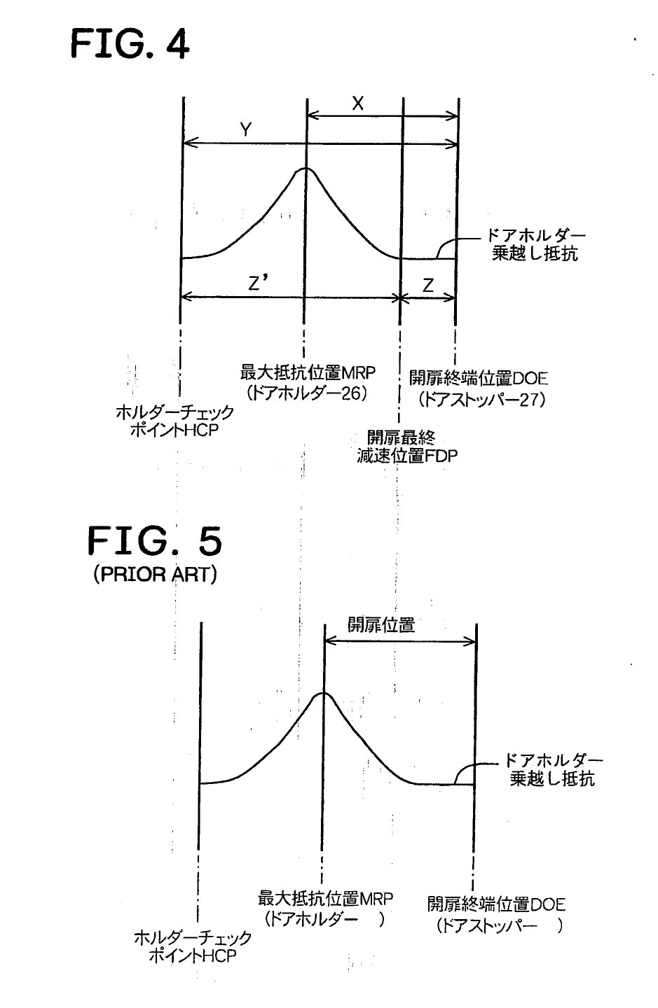

As shown in FIG. 1, to the guide rail 13 of the vehicle body 12, a door holder 26 for holding the sliding door 11 at the door-open position is attached. The door holder 26 of the present embodiment is an overcoming holding type holder having an elastic projecting strip made of a bending plate spring or an elastic rubber, or an inelastic mere projecting strip. When the sliding door 11 moves in the door opening direction, the door 11 passes the holder check point HCP, as shown in FIG. 4, and the door 11 then gets over the maximum resistance position MRP of the door holder 26, and after that, the door runs into a door stopper 27 fixed to the vehicle body at the door-open end DOE which is the limit position where mechanical sliding in the door opening direction is possible, and the door opening finishes. The door-open position means the position between the maximum resistance position MRP of the door holder 26 and the door-open end DOE, and generally, it has a width X of about 20 to 40 mm. The overcoming resistance of the door holder 26 is shaped like a mountain, as shown in FIG. 4.

In FIG. 2, to a drum shaft 16A of the wire drum 16, a cam disk 28 is supported. The cam disk 28 is set to perform one rotation when the wire drum 16 performs three to four rotations. The three to four rotations of the wire drum 16 is equal to the moving quantity of the whole stroke of the sliding door 11, and accordingly, when the sliding door 11 moves from the door-open position to the door-closed position and vice versa, the cam disk 28 performs just one rotation. Close to the cam disk 28 from outside, a holder switch 29 which is switched from ON to OFF by the contact with the cam disk 28 is provided. The switching point of on/off of the holder switch 29 is the holder check point HCP. The holder check point HCP is set on the door closing side of the maximum resistance position MRP of the door holder 26, and the distance Y between the holder check point HCP and the door-open end DOE is longer than the width X. The holder check point HCP is set by the holder switch 29 provided in the interior of the powered sliding device 10, and therefore, the position of the holder check point HCP is fluctuated by the dispersion of the mounting position of the holder switch 29 or the change of the length of the wire cables 19, 20 because of the aged deterioration or the like, and the distance Y is also fluctuated.

In FIG. 2, to the rotational shaft 17A, a slit disk 30 is supported. The slit disk 30 rotates together with the wire drum 16. The slits of the slit disk 30 are detected by a photo sensor 31. The sliding quantity (sliding position) of the sliding door 11 is found by measuring the rotational quantity of the slit disk 30 by the photo sensor 31, and the sliding speed of the sliding door 11 is found by measuring the rotational speed of the slit disk 30, and the sliding direction of the sliding door 11 is found by measuring the rotating direction of the slit disk 30.

In FIG. 4, on the door opening side of the maximum resistance position MRP of the door holder 26, the opening speed final decelerating position FDP which is the essential point of the present invention is set. The distance Z between the door-open end DOE and the final decelerating position FDP is shorter than the width X, and about 10 mm is preferable.

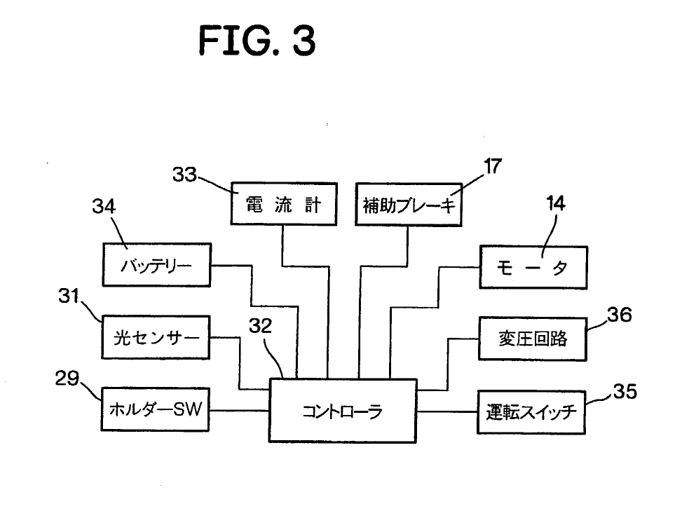

FIG. 3 is a block diagram for performing the control operation according to the present invention. The block diagram has a controller 32, an ammeter (motor load detector) 33 for measuring the current flowing in the motor 14, a battery 34, an operating switch 35, and a transformation circuit 36.

### OPERATION

When the operating switch 35 is operated to the door opening side, the door opening operation of the sliding control is performed by the controller 32, and by the motor 14, the wire drum 16 is rotated in the door opening direction, and the sliding door 11 starts to slide in the door opening direction.

When the cam disk 28 is rotated by the continuing of the opening sliding movement of the door and the holder switch 29 is switched from on to off, the controller 32 can detects the passing through the holder check point HCP of the sliding door 11, and consequently, the controller 32 starts the integration of the pulse signals from the photo sensor 31. Then, the sliding door 11 slides in the door opening direction as it is, the sliding door 11 gets over the door holder 26, and runs into the door stopper 27 at the door-open end DOE. when the sliding door 11 runs into the door stopper 27, the sliding quantity of the sliding door 11 from the holder check point HCP to the door-open end DOE is found from the number of pulse signals from the holder check point HCP to the door-open end DOE, and the distance Y from the holder check point HCP to the door-open end DOE is found.

Next, the controller 32 calculates the proper value of the distance Z′ from the holder check point HCP to the final decelerating position FDP on the basis of the relation between the actually measured distance Y and the specified distance Z between the door-open end DOE and the final decelerating position FDP. The found proper value of the distance Z′ is used in the next door opening operation.

When the next door opening operation is performed and the sliding door 11 passes through the holder check point HCP, the controller 32 starts the integration of the pulse signals from the photo sensor 31. Then, if the integrated pulse signals become equal to the proper distance Z′, the controller 32 judges that the sliding door 11 has reached the opening speed final decelerating position FDP, and decelerates the sliding door 11 by lowering the supply voltage to the motor 14 by the transformation circuit 36. Accordingly, the sliding door 11 is surely decelerated at the final decelerating position FDP separated from the door-open end DOE by the distance Z, and it can come into contact with the door stopper 27 at the door-open end DOE at a slow speed.

It is preferable to measure the distance Y from the holder check point HCP to the door-open end DOE each time the door opening operation is performed, and according to that result, the data of the distance Z′ should be renewed successively. Thus, by renewing the distance Z′, the effects of the dispersion of the mounting position of the holder check point HCP or the change of the length of the wire cables 19, 20 are removed, and the final decelerating position FDP can accurately be set.

It is preferable to store a temporary value of the distance Z′ between the holder check point HCP and the opening speed final decelerating position FDP in advance in the controller 32. The temporary value of the distance Z′ prevents the strong collision between the sliding door 11 and the door stopper 27 in the first door opening operation.

The decelerating ratio of the sliding door 11 performed in the final decelerating position FDP is a design item to be determined by the factor such as the magnitude of the load of the motor 14.

The deceleration at the final decelerating position FDP is the final deceleration for preventing the strong collision between the sliding door 11 and the door stopper 27. Accordingly, it is also possible to apply the first order deceleration to the sliding door 11 on the basis of the holder check point HCP.

### ADVANTAGE

In the present invention, the opening speed final decelerating position FDP can accurately be set near the door-opening end DOE on the door opening side of the maximum resistance position MRP of the door holder 26, and therefore, it is possible to reduce the time necessary for the finish of the door opening while reducing the shock when the sliding door 11 comes into contact with the door stopper 27.

What is claimed is:

1. A control method of a powered sliding device which slides, in a door opening direction and in a door closing direction by power of a motor, a vehicle sliding door which is kept in a door-open position set through a specified width X in the door closing direction from a mechanical door-open end DOE by overcoming resistance of an overcoming holding type door holder after the door is slid to the door-open end DOE, wherein the power of the motor is suppressed when the sliding door reaches an opening speed final decelerating position FDP set on a door opening side of a maximum resistance position MRP of the door holder by the door opening power of the motor: comprising the steps of;
setting a switching point where a holder switch for detecting entering to the door-open position of the sliding door and separation from the door-open position is switched, to a holder check point HCP;
setting the final decelerating position FDP to a position separated from the door-open end DOE to the door closing side by a specified distance Z;
measuring a distance Y from the holder check point HCP to the door-open end DOE on the basis of a sliding quantity of the sliding door when the sliding door reaches the door-open end DOE after the door passes the holder check point HCP by the door opening power of the motor;
finding a proper value of a distance Z′ from the holder check point HCP to the final decelerating position FDP by calculation from the distance Y found from the sliding quantity of the sliding door and the specified distance Z between the final decelerating position FDP and the door opening end position DOE; and
considering that the sliding door reaches the final decelerating position FDP, when the sliding door slides by the distance Z′ after passing the holder check point HCP by door opening power of the motor.

2. The control method according to claim 1, wherein the distance Y is measured each time the door opening operation of the sliding door is performed.
